(19) United States
(12) Patent Application Publication
(10) Pub. No.: US 2017/0108573 A1
(43) Pub. Date: Apr. 20, 2017

(54) METHOD FOR SOLAR TRACKING AND LIGHT COLLECTION

(71) Applicant: INSTITUTE OF NUCLEAR ENERGY RESEARCH, ATOMIC ENERGY COUNCIL, EXECUTIVE YUAN, R.O.C, TAOYUAN CITY (TW)

(72) Inventors: HONG-CHENG HUANG, TAOYUAN CITY (TW); HONG-YIH YEH, TAOYUAN CITY (TW); WEN-FU CHEN, TAOYUAN CITY (TW)

(21) Appl. No.: 15/254,168

(22) Filed: Sep. 1, 2016

(30) Foreign Application Priority Data
Oct. 16, 2015 (TW) 104133942

(51) Int. Cl. G01S 3/786

(52) U.S. Cl. CPC G01S 3/7861

(57) ABSTRACT

A method for solar tracking and light collection is revealed. Two motors are used to control a light collector rotating in the north-south direction and a frame rotating in the east-west direction respectively to aim the light collector toward the sun for collecting sunlight all the times. The two motors work according to a path table produced by calculation of elevation angles and roll angles.

### BACKGROUND OF THE INVENTION

Field of the Invention

The present invention relates to a method for light collection, especially to a method for solar tracking and light collection applied to solar lighting systems with lower power consumption and higher reliability.

Descriptions of Related Art

A solar tracking light collection system for illumination has been developed for improvement of global warming and energy problem. The system can be applied to lighting in the room at home or public facility lighting such as in the parking garage, or indoor plant illumination for photosynthesis.

Two most commonly used dual axis solar trackers are azimuth-altitude dual axis trackers (AADAT) and tip-tilt dual axis trackers (TTDAT). The AADAT system uses a horizontal coordinate system to track the sun. The azimuth-altitude dual axis tracer has a primary axis-the azimuth axis vertical to the ground and the secondary axis-elevation axis. The horizontal coordinate system is defined by the observers' location. The sun viewed from different locations on Earth at the same time will have different values of altitude (or elevation) and azimuth. Moreover, the AADAT system uses a large ring mounted on the ground with the array mounted on a series of rollers. This allows AADAT to support much larger solar tracking systems.

The TTDAT system uses an equatorial coordinate system to track the sun. The two parameters (declination angle and house angle) that define the equatorial coordinate system have small changes in angle. Thus the energy consumed for sun-tracking is reduced. The regular change of the house angle results in the simplified design of the tracking controller. However, the accompanying shortcomings include difficulty in alignment of the rotation axis of the house angle with the rotation axis of the earth and accuracy easily affected by wind and external forces.

### SUMMARY OF THE INVENTION

Therefore it is a primary object of the present invention to provide a method for solar tracking and light collection in which two motors are driven according to a coordinate of a target derived from the elevation angle and the roll angle for aiming a solar tracker toward the sun precisely. The method is based on angle conversion with reference of solar elevation and azimuth angles.

It is another object of the present invention to provide a method for solar tracking and light collection in which a light collector is used for sunlight collection. At least one condenser lens is disposed on the light collector and used for light concentration. The sunlight is further guided to optical fiber for light transmission and further uses. For example, sunlight is introduced into indoor space for lighting.

It is a further object of the present invention to provide a method for solar tracking and light collection that requires a light weighted hardware with wall-mounted design. The problem of difficult alignment of the hour angle shaft with the earth's rotation axis will not happen during installation. The hardware also has higher reliability without being affected by wind and external forces.

It is a further object of the present invention to provide a method for solar tracking and light collection that reduces the amount of rotation of the motors compared with the conventional solar tracker having the same accuracy. This helps reduce power consumption.

In order to achieve the above objects, a method for solar tracking and light collection according to the present invention includes the following steps. First provide an elevation angle in the north-south direction to a microprocessor so that the microprocessor controls a first motor to rotate a light collector on a first axis. Then provide a roll angle in the east-west direction to the microprocessor so that the microprocessor controls a second motor to rotate a frame under the light collector on a second axis and aim the light collector toward the sun. The first axis and the second axis are perpendicular to each other.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing hardware required by an embodiment according to the present invention;

FIG. 2 is a flow chart showing steps of an embodiment according to the present invention;

FIG. 3A and FIG. 3B are schematic drawings showing sun trajectory of an embodiment according to the present invention.

### DETAILED DESCRIPTION OF THE PREFERRED EMBODIMENT

In order to learn features and functions of the present invention, please refer to the following embodiment and detailed description.

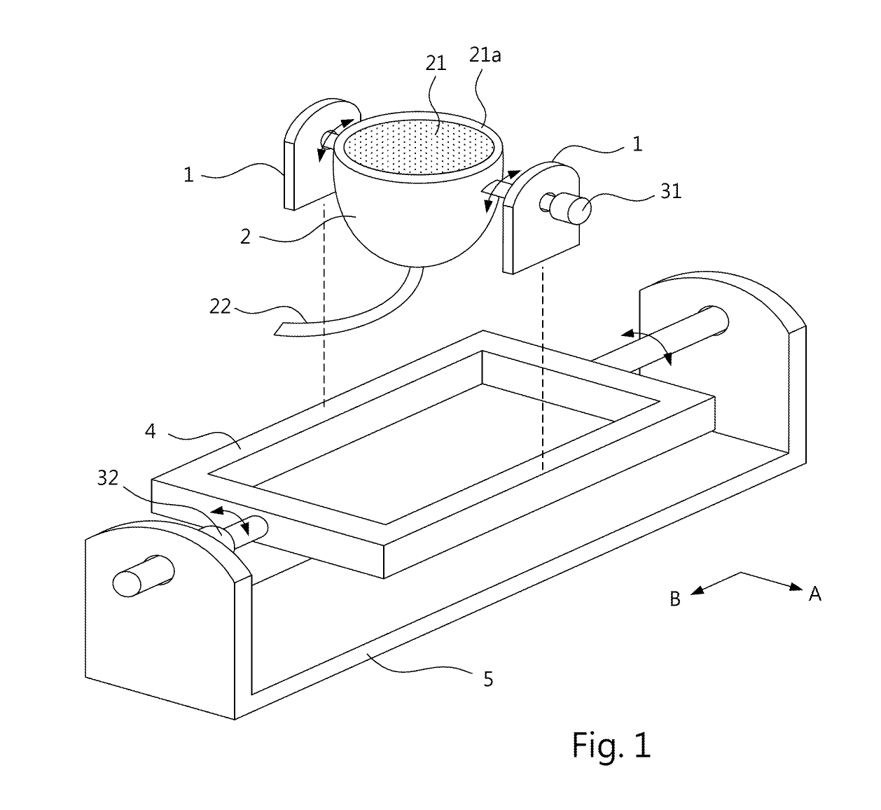

Refer to FIG. 1, a hardware structure used to execute the method of the present invention includes a support base 1, a light collector 2, a first motor 31, a frame 4 and a second motor 32. The light collector 2 is pivotally connected to the support base 1 while the first motor 31 is connected to the light collector 2. The frame 4 is arranged under the light collector 2 and the second motor 32 is connected to the frame 4.

The light collector 2 consists of a condenser lens 21 and an light collecting optical fiber 22. The condenser lens 21 is set on an opening 21a of the light collector 2 while the light collecting optical fiber 22 is disposed on a focal point of the condenser lens 21 of the light collector 2 for receiving sunlight collected by the condenser lens 21. Moreover, the hardware further includes a seat 5 that is pivotally connected to the frame 4 and fixed on the ground.

During operation, the present invention is based on angle conversion with reference of solar elevation angles and solar azimuth angles. Two sets of motors are driven at the elevation angle in the north-south direction and the roll angle in the east-west direction to fit a target coordinate derived from the angle conversion with reference of solar elevation and azimuth angles to aim the sun tracking sunlight collection system toward the sun at all times. According to the structure mentioned above, the light collector 2 is driven by the first motor 31 to rotate around the first axis A that points in the east-west direction in the space. The elevation angle of one side of the light collector 2 disposed with the condenser lens 21 on a north-south arc is changed owing to rotation of the light collector 2 around the first axis A during sun tracking process.

As to the frame 4, it is driven by the second motor 32 to rotate around the second axis B. The second axis B points in the north-south direction in the space and is perpendicular to the first axis A. The light collector 2 is arranged over the frame 4. Thus the roll angle of one side of the light collector 2 disposed with the condenser lens 21 on an east-west arc is changed owing to rotation of the frame 4 around the second axis B during sun tracking process.

In other words, the method for solar tracking and light collection of the present invention is performed by a two-motor equipment. A microprocessor (not shown in figures) is electrically connected to the first motor 31 and the second motor 32 for converting coordinates of the sun being tracked into signals and outputting to the two motors. Then the two motors are driven to rotate the light collector 2 in the north-south direction (based on the first axis A in the east-west direction) and the frame 4 in the east-west direction (based on the second axis B in the north-south direction) in turn. Thus the light collector 2 is always facing the sun to collect sunlight to a focal point therein through the condenser lens 21 and transmit the sunlight to other equipments such as indoor lighting fixtures.

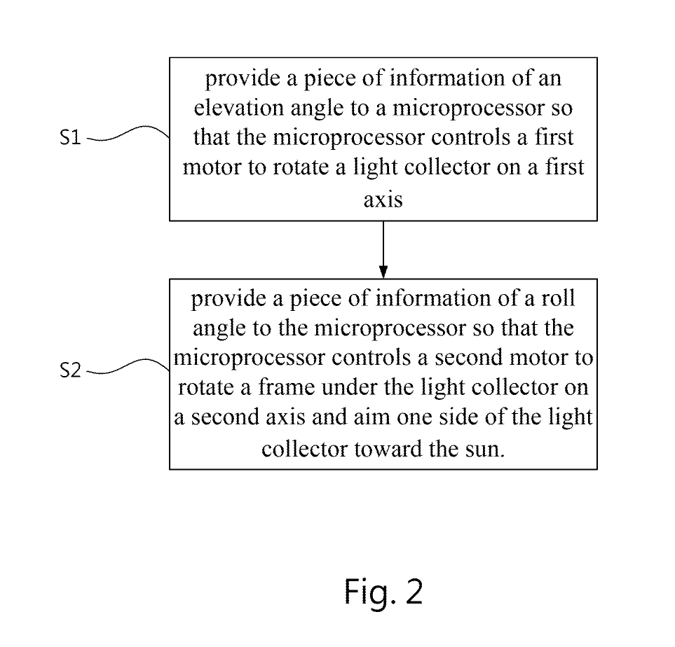

Refer to FIG. 2, a method for solar tracking and light collection according to the present invention includes the following steps:
Step S1: provide a piece of information of an elevation angle to a microprocessor so that the microprocessor controls a first motor to rotate a light collector on a first axis;
Step S2: provide a piece of information of a roll angle to the microprocessor so that the microprocessor controls a second motor to rotate a frame under the light collector on a second axis and aim one side of the light collector toward the sun.

The first axis and the second axis are perpendicular to each other.

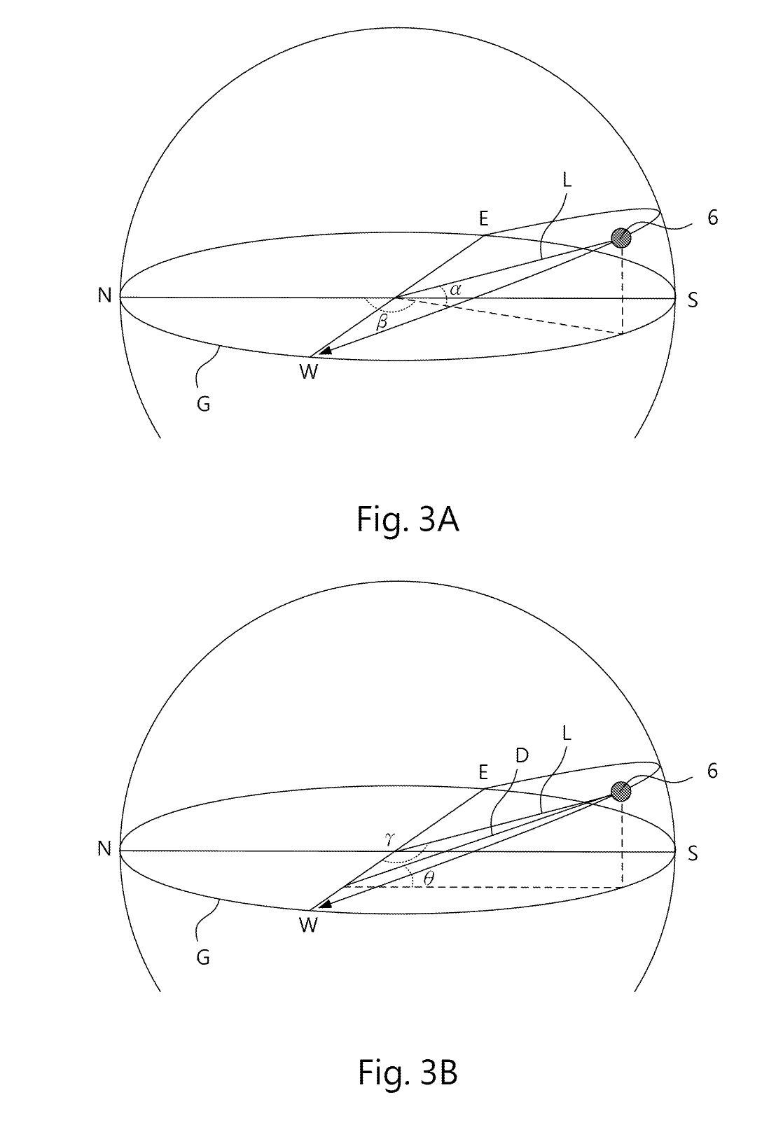

Refer to FIG. 3 A and FIG. 3B in an embodiment of the present invention, the reference solar elevation angle, the angle between the ground horizon (G) and a line connecting the solar tracker and the sun, is α degrees. The ground horizon is 0 degree. A line D is a perpendicular line of the solar position to the east-west axis and there is the foot of the sun on the east-west axis. The reference solar azimuth angle, the angle between true North and the projection of a line L on the XY plane (the ground horizon G), is β degrees. True North is 0 degree azimuths. The reference solar elevation angle a and the reference solar azimuth angle β at certain times of the day are already known (such as information revealed by National Renewable Energy Laboratory (NREL)). Thus the unknown elevation angle θ in the north-south direction and roll angle γ in the east-west direction can be obtained by calculation and then a path table is produced. The elevation angle θ is the angle between the line D and the true North while the roll angle γ is the angle between the line L and the true West. The calculation is performed by the following formulas. x is east-west component of the projection of the line L on the ground horizon, y is north-south component of the projection of the line L on the ground horizon, and z is the distance between the line L and the ground horizon.

x=L*cos α*sin(π−β) (formula 1)

y=L*cos α*cos(π−β) (formula 2)

z=L*sin α (formula 3)

tan(θ)=z/y (formula 4)

θ=tan⁻¹(z/y)=tan⁻¹[(L sin α)/(L cos α(−cos β))] (formula 5)

θ=tan⁻¹[−(tan α/cos β)] (formula 6)

cos γ=(x/L)=(L*cos α*sin(π−β))/L=cos α*sin β (formula 7)

γ=cos⁻¹(cos α*sin β) (formula 8)

According to the known reference solar elevation angle α, the known reference solar azimuth angle β, and the formulas of the elevation angle θ in the north-south direction and the roll angle γ in the east-west direction, first check whether the reference azimuth angle β is no less than 90 degrees and smaller than 270 degrees (90≦β<270). If the answer is yes, add 180 degrees to the angle θ to produce the path table after calculation. If the answer is no, produce the path table directly by calculation. While in use, values of the path table are converted to the path defined by the hardware. Around the first axis A, the East is 0 degree and the angle rotated clockwise is positive. Around the second axis B, the South is 0 and the angle rotated counterclockwise is positive. An origin has the coordinates (0, 0) on the first axis and on the second axis respectively. Next the solar tracker is connected to software required for operation. Then the first motor 31 and the second motor 32 are set to zero. Both the first axis A and the second axis B are back to the origin. At last, make fine adjustments of other parameters such as time, date, etc. and turn on automatic tracking.

The present invention has the advantage of lowered cost of the hardware required. Thus the price of the product is affordable. Moreover, the problem of difficult alignment of the hour angle shaft with the earth's rotation axis will not occur while installing the hardware of the present invention. The hardware of the present invention is not affected by wind and external forces. According cumulative data of rotation angle for one year, automatic sun tracking by using path tables reduces about 20% to 24% the amount of rotation of the motors compared with the sun tracking system based on the azimuth and with the same accuracy. This is beneficial to power-saving and reliability improvement.

In summary, a method for solar tracking and light collection of the present invention increases efficiency of sunlight utilization, extends the duration of sunshine, and increases sunshine hours for indoor space lighting. For example, lighting hours of rooms and bathrooms inside the building are reduced to save power. Moreover, people don't need to go out for natural sunshine and healthy sunbathing. For disabled elderly and patients on the bed, this is good for their health. Thus the present invention is practical to use and economical to make.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A method for solar tracking and light collection comprising the steps of:
providing an elevation angle information in the north-south direction to a microprocessor so that the microprocessor controls a first motor to rotate a light collector on a first axis; and
providing a roll angle information in the east-west direction to the microprocessor so that the microprocessor controls a second motor to rotate a frame under the light collector on a second axis and aim one side of the light collector toward the sun;
wherein the first axis and the second axis are perpendicular to each other.

2. The method as claimed in claim 1, wherein the elevation angle information in the north-south direction and the roll angle information in the east-west direction are calculated by the following formulas:
θ=tan⁻¹[−(tan α/cos β)];and
γ=cos⁻¹(cos α*sin β);
wherein θ represents the elevation angle in the north-south direction, γ represents the roll angle in the east-west direction, α represents a reference solar elevation angle, and β represents a reference solar azimuth angle.

3. The method as claimed in claim 2, wherein 180 degrees is added to the elevation angle in the north-south direction if the reference solar azimuth angle is no less than 90 degrees and smaller than 270 degrees (90≦β<270).
